(19) United States
(12) Patent Application Publication
(10) Pub. No.: US 2026/0040182 A1
(43) Pub. Date: Feb. 5, 2026

(54) CONDITIONAL HANDOVER ENHANCEMENTS

(71) Applicant: Nokia Technologies Oy, Espoo (FI)

(72) Inventors: Ahmad AWADA, Munich (DE); Stepan KUCERA, Munich (DE)

(21) Appl. No.: 18/997,413

(22) PCT Filed: Jul. 27, 2022
(86) PCT No.: PCT/IB2022/056958

§ 371 Date: Jan. 21, 2025

(51) Int. Cl. H04W 36/36; H04W 36/00

(52) U.S. Cl. CPC H04W 36/362; H04W 36/0061

(57) ABSTRACT

Methods, apparatuses, and computer program products provided herein improve upon conditional handover (CHO) techniques that handle continuous network connectivity when a user equipment (UE) moves between network cells. The disclosed techniques can be utilized in scenarios in which a path of a user equipment (UE) between 5 various network nodes is known, such as in a high-speed train use case. According to disclosed methods, a source network node triggers CHO preparation toward a plurality of target network nodes. A last prepared network node receives an indication to trigger further CHO preparation toward additional target network nodes. Since the path of the UE is known by the UE and/or in the network, the UE evaluates the CHO condition for 10 only the next target network node in the path. CHO techniques may therefore be enhanced by improving the efficiency of CHO according to the disclosed methods.

### TECHNOLOGICAL FIELD

An example embodiment relates generally to wireless communications and, more particularly, but not exclusively, to improvements and enhancements to Conditional Handover (CHO).

### BACKGROUND

Conditional Handover (CHO) is a mobility enhancement defined in Third Generation Partnership Project (3GPP) Release 16 (Rel-16), targeted at reducing radio link failures and handover failures, especially those caused due to a user equipment (UE) moving between cells in a network. CHO is similar to a baseline handover procedure of New Radio (NR) Release 15 (Rel-15).

In CHO, instead of preparing one target cell as in the baseline handover scenario, multiple candidate target cells are prepared in advance in the network, which enables the handover command to be sent to the UE earlier than in a baseline handover, and when the radio signal is still strong, rather than when connectivity becomes challenging as in the baseline handover case. When received, the UE stores the command, instead of applying it immediately. The UE performs the handover according to the stored command when a condition configured in the UE, such as a condition relating to signal strength measurement, is satisfied for one of the configured candidate target cells, and then the UE executes the handover and connects to the target node.

### BRIEF SUMMARY

An example message sequence chart is shown for CHO in FIG. 1. The first operations 1-9 are similar to the baseline handover of NR Rel-15 [Technical Specification (TS) 38.300]. A configured measurement event triggers the UE 100 to send a measurement report in operation 1. Based on this report, the source node 102 (e.g., gNB) can prepare one or more target nodes 104, or target cells for the handover (CHO Request as shown by operation 3), and CHO Request Acknowledge as shown by operation 7 (and operation 8), and then send an RRC Reconfiguration (including CHO condition) to the UE a shown in operation 9. Operations 5 and 6 include admission control at the target node 104 and/or other potential target nodes 104.

In operation 10, the UE 100 evaluates the CHO condition, and in operation 11, if the CHO condition is met for the target cell, and the data transfer to and/or from the source cell can be stopped. Operation 12 includes the transmission of physical random access channel (PRACH) Preamble and Operation 13 includes the reception of random access channel (RACH) Response. Operation 14 includes transmission of an indication of Radio Resource Control (RRC) Reconfiguration Complete. Operation 15 includes an indication of handover success from the target node 104 to source node 102, and operation 16 includes stopping data transfer between the UE 100 and source node 102. At operation 17, sequence number (SN) status transfer is indicated between the source node 102 and target node 104. Data forwarding from the source node 102 to the target node 104 occurs at operation 18. Operation 19 includes releasing CHO preparation from the source node 102 to the target node 104, and at operation 20 path switch occurs, and corresponding updates to the User Plane Function (UPF 108) and Access and Mobility Management Function (AMF) 110.

For baseline handover of NR Rel-15, the UE will immediately access the target cell to complete the handover. Instead, for CHO, the UE will only access the target cell once an additional CHO execution condition is met (e.g., the handover preparation and execution phases are decoupled). The condition is configured, e.g., by the source node in RRC Reconfiguration of Operation 9 in FIG. 1. For intra-frequency handover, an A3, event defined at least in TS 38.331 can be configured as CHO execution condition where the UE triggers the CHO execution when the measurement of target cell is offset better than the measurement of the serving cell by some offset for some Time-to-Trigger (TTT). For inter-frequency handover, event A5 is configured where the UE triggers CHO execution when the measurement of serving cell is below threshold 1 and the measurement of target cell is higher than threshold 2 for TTT.

In CHO, the UE can be prepared with up to 8 candidate target cell configurations. Moreover, two types of data forwarding from source cell to target cell are possible, including late data forwarding and early data forwarding.

According to late date forwarding, the source node triggers the data forwarding to the target node after receiving Handover Success message from the target node (as shown in operations 15-18). The configuration is called late data forwarding as it occurs after the UE has performed random access to the target cell. Late data forwarding causes some interruption for the UE as the target node cannot serve the UE immediately after the UE completes the handover execution.

According to early data forwarding, the source node can trigger data forwarding to one or multiple candidate target node after sending the configurations of the candidate target cells in operation 9.

Given that the source node is not aware beforehand to which target node the UE will perform random access to, the data forwarding needs to be performed to multiple candidate target nodes. This would reduce the interruption caused by late data forwarding but it increases the signaling overhead over the Xn interface.

Increases in demand for continuous connectivity while a UE is mobile, and sometimes mobile at high speeds and/or ultra high-speeds, create challenges for networks including configurations utilizing CHO. “Hyperloop” is a proposed high-speed transportation system for both people and goods based on a vacuum tube train. A maglev (magnetic levitation) train is deployed in partly evacuated tubes or tunnels where reduced air resistance permits travel at very high (hypersonic) speeds with relatively little power.

While there are multiple options in terms of technical design, hyperloop systems generally consist of three components: tubes, pods, and terminals. The tube is a large sealed, low-pressure system (usually a long tunnel). The pod is a coach pressurized at atmospheric pressure that runs substantially free of air resistance or friction inside the tube, using aerodynamic or magnetic propulsion. The terminal handles pod arrivals and departures while maintaining low atmospheric pressure.

Fifth Generation (5G) New Radio (NR) networks may be used to offer high-performance connectivity in high-speed scenarios such as in the Hyperloop. For example, BOOST provides train-to-ground communications, as does the High-Speed Trains work item in 3GPP RAN WG3.

In a hyperloop, trains move at extremely high speeds, such as 1000 kilometers per hour, or even faster, which makes reliable UE handover from one cell to another difficult as cell coverage areas can be relatively small. For example, terminals may be a few hundred meters from other terminals to ensure high signal-to-noise (S/NR) for high-capacity links. The proximity of cells may, for example, deliver high-resolution real-time video stream from the remote cockpit client). Prior techniques such as a conventional handover (baseline handover mechanism of NR Rel-15) is not effective as the UEs might miss receiving the handover command on-time from the network given the very-high speed of the train.

Moreover, it would beneficial if UEs installed on high-speed trains or accompanying users inside the train have the candidate target cell configurations beforehand such that the UE can apply them when needed. Regarding CHO implementations, as of Rel-18, the UEs are able to receive multiple CHO configurations from the source node which can be applied (and remain valid) after performing a handover. For instance, in the example of FIG. 2, the UE can receive from serving cell 1 the CHO configurations of cells 2, 3, 4 and 5 where CHO configuration of cell 2 can be used by the UE to execute the handover from cell 1 to 2, CHO configuration of cell 3 to execute the handover from cell 2 to cell 3, and so on.

Certain embodiments disclosed herein provide an efficient solution to this high-speed mobility scenario by introducing enhancements for CHO. At least some of the problems addressed according to certain embodiments are described below.

One challenge addressed according to certain embodiments includes improving session continuity without interruption, by making available the user plane packets available in the target node at the time of cell change. This can be achieved by using early data forwarding. This can be implemented given that the path of the hyperloop train is pre-determined and the next candidate target cell is known beforehand, however, forwarding the user plane packets to multiple target cells leads to a high and unnecessary signaling overhead over the network (e.g., Xn interface).

Another challenge includes, given that the UE is pre-configured by e.g. serving cell X_1 with NI CHO configurations for the upcoming N1 target cells, the last prepared target cell X_N1 (from the N1 cells) needs to re-configure the UE for next upcoming N2 candidate target cell. Note that N2 can be different than N1 as cell X_1 and X_N1 may have different number of neighbor cells connected with Xn interface. The issue is that the last cell serving cell (e.g, target cell X_N1) may not be aware that it needs to re-trigger the CHO preparation for the next upcoming N2 candidate target cells.

In CHO Rel. 16, the UE starts to evaluate all the CHO conditions that are associated with candidate target cell configurations upon receiving these configurations (as shown in operation 9 of FIG. 1). This is needed because the UE is not aware of the target cell to which it will execute a handover. However, in the hyperloop train scenario, the next target cell is known beforehand and as such it would be inefficient to start the evaluation of the CHO conditions for candidate target cells that the UE will visit later on after performing a handover to a different target cell.

Certain embodiments disclosed herein exploit an observation that in any train scenario, the train path or trajectory is known or can be determined within the network. The path information can be derived either explicitly from the track operator (for example, by pre-configuring the rail track plans or by adaptively monitoring the operation of the linear motor that accelerates the maglev train), or implicitly from the network, e.g. the 5G NR network, itself (for example, by using the native Location Management Function (LMF) that allows positioning the train in real-time using integrated 5G NR capability). In this context, at least some disclosed embodiments include at least two techniques depending on whether the path information of the UE is known by the UE, or not necessarily known by the UE (but known in the network).

In a scenario in which the path information is known in the network or able to be determined in the network, certain embodiments according to a first technique, are enabled by at least a standard core-based positioning server such as the LMF. The first technique includes at least Aspects #1-5 described below, which are numbered only for the purpose of reference, and are not intended to limit the scope of the disclosure. In a second technique, positioning information can be based on, e.g., a 5G NR, UE that is aware of its precise position by the LMF by using the standardized LTE Positioning Protocol (LPP). The second technique includes at least Aspects #5-8 described below, which are numbered only for the purpose of reference, and are not intended to limit the scope of the disclosure.

In the first technique, when the path information of the UE is known or can be determined in the network, but not necessarily known by the UE, at least the following Aspect #1 is performed. Based on the list X of cells that the UE will visit along its path, at least processing circuitry of the serving cell (e.g., cell 1 in FIG. 2) triggers a proactive conditional handover preparation of the candidate target cells (e.g., cells 2, 3, and 4) whose gNB has Xn interface with serving (source) gNB or network node.

Further in the first technique, during the conditional handover preparation, at least the following Aspect #2 is implemented. At least processing circuitry and/or a communication interface of source gNB (controlling serving cell 1) indicates to another target gNB 2 (controlling the next target cell 2) the cell identifier such as a cell identifier (e.g., PCI) of the target cell to which it shall perform early data forwarding (e.g. target cell 3). Aspect #2 therefore addresses the high and unnecessary signaling overhead described above with regard to early data forwarding toward multiple cells, and instead initiates early data forwarding toward a defined number of cells based on the path of the UE.

Further in the first technique, during the handover preparation, at least the following Aspect #3 is performed. According to Aspect #3, at least processing circuitry and/or a communication interface of the source gNB (controlling serving cell 1) indicates to another target gNB 3 (controlling second next target cell 3) the cell identifier (e.g., PCI) of the target cell to which it shall perform early data forwarding (e.g. target cell 4) and the cell identifier (e.g., PCI) of the source cell of handover (e.g., target cell 2). The latter cell identifier is used since target gNB 3 (controlling target cell 3) needs to know to which serving cell it shall send “Handover Success” message (operation 15 in FIG. 1). The indication of the physical cells provided according to certain embodiments disclosed herein addresses the high and unnecessary signaling overhead described above with regard to early data forwarding toward multiple cells.

Further in the first technique, during the handover preparation, at least the following Aspect #4 is provided. At least the processing circuitry and/or communication interface of the source gNB (controlling serving cell 1) indicates to another target gNB 4 (controlling the last target cell 4) the cell identifier (e.g., PCI) of the source cell of handover (e.g. target cell 3), a flag to trigger new CHO preparation to other target cells and the list X of cells that the UE will visit. This Aspect #4 allows repeating the disclosed preparatory procedure iteratively. It is noted that the flag and list X are needed since target gNB 4 prepares the next upcoming N2 candidate target cells for the UE whose gNB has Xn interface with target gNB 4. The provision of the flag to trigger new CHO preparation according to certain embodiments addresses the challenge described above with regard to the last cell serving cell, e.g., target cell X_N1 may not be aware that it needs to re-trigger the CHO preparation for the next upcoming N2 candidate target cells.

Further in the first technique, at least the following Aspect #5 is implemented. In Aspect #5, when providing the CHO configurations for the candidate target cells, the network, such as via at least processing circuitry and a communication interface of serving cell 1, indicates to the UE the order it should evaluate the CHO execution condition. For instance, the serving cell can indicate that the CHO execution condition of target cell 2 shall be evaluated when the UE is served by (serving) cell 1, CHO execution condition of target cell 3 shall be evaluated when the UE is served by cell 2 and so on. This indication to evaluate the CHO execution condition can reduce or eliminate the inefficiencies that would otherwise be present if the evaluation of the CHO conditions begin immediately for candidate target cells that the UE will visit after performing a handover to a different target cell.

The second technique provided herein is performed when the path information is known in the UE. According to the second technique of certain embodiments disclosed herein, at least an Aspect #6 is performed including, based on the list X of cells that the UE will visit along its path, the UE informs serving cell 1 about the next candidate target cells. Upon receiving this information, the source cell, with at least processing circuitry and a communication interface, can trigger the preparation of the candidate target cells 2, 3, 4, similarly as described above with respect to the first method, Aspects #2-4. Note that in Aspect #4, when performed by the second technique, the source gNB may not need to include the flag and the list X of cells as it can be informed now by the UE as shown in Aspect #7, described below.

The second technique according to certain examples embodiments further includes at least Aspect #7, including, based on the list X of cells that the UE will visit along its path and the list of CHO configurations received from the serving cell 1, the UE informs, with at least processing circuitry and a communication interface, the last serving cell 4 about the next candidate target cells that shall be prepared. The UE transmitting the indication to the last serving cells, as provided according to certain embodiments, addresses the challenge described above with regard to the last cell serving cell, e.g., target cell X_Nl potentially not being aware that it needs to re-trigger the CHO preparation for the next upcoming N2 candidate target cells.

The second technique according to certain examples embodiments further includes at least Aspect #8, including, based on the list X of cells that the UE will visit along its path and the list of CHO configurations received from the serving cell 1, the UE determines, with at least processing circuitry and a communication interface, the CHO execution condition that needs to be evaluated depending on the PCI of the serving cell. For instance, the UE evaluates the CHO execution condition of target cell 2 when it is served by (serving) cell 1, CHO execution condition of target cell 3 shall be evaluated when the UE is served by cell 2 and so on. The UE determination of the CHO execution condition to be evaluated reduces or eliminates the inefficiencies that would otherwise be present if the evaluation of the CHO conditions were to begin immediately for candidate target cells that the UE will visit later on after performing a handover to a different target cell.

An apparatus is provided, comprising at least one processor and at least one memory storing instructions that, when executed by the at least one processor, cause the apparatus at least to trigger conditional handover (CHO) preparation toward a plurality of target network nodes in a path along which a user equipment (UE) is determined to move, wherein the CHO preparation comprises causing transmission, toward a respective recipient target network node, of a cell identifier of a next target network node of the recipient target network node, and, if a preceding network node of the recipient target node is not the apparatus, a cell identifier of the preceding network node of the recipient target network node.

The instructions, when executed by the at least one processor, further cause the apparatus at least to cause transmission, toward a last network node triggered for CHO preparation by the apparatus, of an indicator to trigger additional CHO preparation toward other target network nodes and a list of cell identifiers of the respective other target network nodes.

According to certain embodiments, the path in which the UE is determined to move comprises a path from the apparatus, configured as a first network node, to a second network node, to a third network node, and to a fourth network node, wherein the CHO preparation further comprises causing transmission, toward the second network node, of a cell identifier of the third network node, and causing transmission, toward the third network node, of a cell identifier of the fourth network node and a cell identifier of the second network node. The indicator to trigger the additional CHO preparation, and the list of cell identifiers are transmitted from the apparatus toward the fourth network node.

The instructions, when executed by the at least one processor, further cause the apparatus at least to cause transmission, toward the UE, of an indication of a sequence of CHO conditions to be evaluated, wherein a respective CHO condition is associated with a respective network node in the path in which the UE is determined to move.

Another apparatus is provided, comprising at least one processor and at least one memory storing instructions that, when executed by the at least one processor, cause the apparatus at least to receive from a source network node a cell identifier of a next target network node, and perform early data forwarding toward the next target network node.

The instructions, when executed by the at least one processor, further cause the apparatus at least to at least receive an indication, from the source network node, to trigger conditional handover (CHO) preparation toward a plurality of target network nodes indicated by the source network node, and in response thereto, trigger the CHO preparation toward the plurality of target network nodes.

The instructions, when executed by the at least one processor, further cause the apparatus at least to receive from the source network node a cell identifier of a preceding network node and in response thereto, cause transmission of a handover success message to the preceding network node based on the cell identifier.

Another apparatus is provided, comprising at least one processor and at least one memory storing instructions that, when executed by the at least one processor, cause the apparatus at least to receive an indication of a sequence of conditional handover (CHO) conditions to be evaluated, wherein a respective CHO condition is associated with a respective network node in a path along which the apparatus is determined to move, and determine a conditional handover (CHO) condition to be evaluated for a next network node toward which the apparatus moves, based on a cell identifier of a source network node and path information of the apparatus. The path information of the apparatus is received from a network entity and comprises respective cell identifiers of network nodes toward which the apparatus moves.

An apparatus is provided, comprising at least one processor and at least one memory storing instructions that, when executed by the at least one processor, cause the apparatus at least to cause transmission, to a source network node, of an indicator to trigger CHO preparation to target network nodes in a path along which the apparatus moves, and a list of cell identifiers of the respective target network nodes, receive from the source network node, an indication of conditional handover (CHO) conditions to be evaluated, wherein a respective CHO condition is associated with a respective one of the target network nodes according to the path, and evaluate a respective CHO condition for a next network node toward which the apparatus moves.

The instructions, when executed by the at least one processor, further cause the apparatus at least to cause transmission, to a last network node indicated for CHO preparation by the source network node, of an indicator to trigger additional CHO preparation toward other target network nodes and a list of cell identifiers of the respective other target network nodes.

Another apparatus is provided, comprising at least one processor and at least one memory storing instructions that, when executed by the at least one processor, cause the apparatus at least to receive an indication from a user equipment (UE) served by the apparatus in a network, to trigger condition handover (CHO) preparation with a plurality of target network nodes in a path in which the UE moves, and trigger CHO preparation with the plurality of target network nodes by causing transmission, toward a respective recipient target network node, of a cell identifier of a next target network node of the recipient target network node, and a cell identifier of a preceding network node of the recipient target network node.

A method is provided, including triggering conditional handover (CHO) preparation toward a plurality of target network nodes in a path along which a user equipment (UE) is determined to move, wherein the CHO preparation comprises causing transmission, toward a respective recipient target network node, of a cell identifier of a next target network node of the recipient target network node, and, if a preceding network node of the recipient target node is not a source network node of the cell identifier of the next target node, a cell identifier of the preceding network node of the recipient target network node.

The method further includes causing transmission, toward a last network node triggered for CHO preparation by the source network node, of an indicator to trigger additional CHO preparation toward other target network nodes and a list of cell identifiers of the respective other target network nodes.

In certain embodiments, the path in which the UE is determined to move comprises a path from the source network node, configured as a first network node, to a second network node, to a third network node, and to a fourth network node, wherein the CHO preparation further comprises causing transmission, toward the second network node, of a cell identifier of the third network node, and causing transmission, toward the third network node, of a cell identifier of the fourth network node and a cell identifier of the second network node. The indicator to trigger the additional CHO preparation, and the list of cell identifiers are transmitted from the source network node toward the fourth network node.

The method includes causing transmission, toward the UE, of an indication of a sequence of CHO conditions to be evaluated, wherein a respective CHO condition is associated with a respective network node in the path in which the UE is determined to move.

Another method is provided, including, receiving from a source network node a cell identifier of a next target network node, and performing early data forwarding toward the next target network node. The method further includes receiving an indication, from the source network node, to trigger conditional handover (CHO) preparation toward a plurality of target network nodes indicated by the source network node, and in response thereto, trigger the CHO preparation toward the plurality of target network nodes. The method further includes receiving from the source network node a cell identifier of a preceding network node and in response thereto, cause transmission of a handover success message to the preceding network node based on the cell identifier.

Another method is provided, including receiving an indication of a sequence of conditional handover (CHO) conditions to be evaluated, wherein a respective CHO condition is associated with a respective network node in a path along which a user equipment (UE) is determined to move, and determining a conditional handover (CHO) condition to be evaluated for a next network node toward which the UE moves, based on a cell identifier of a source network node and path information of the UE. The path information of the UE is received from a network entity and comprises respective cell identifiers of network nodes toward which the UE moves.

Another method is provided, including causing transmission, to a source network node, of an indicator to trigger CHO preparation to target network nodes in a path along which a user equipment (UE) moves, and a list of cell identifiers of the respective target network nodes, receiving from the source network node, an indication of conditional handover (CHO) conditions to be evaluated, wherein a respective CHO condition is associated with a respective one of the target network nodes according to the path, and evaluating a respective CHO condition for a next network node toward which the UE moves. The method further includes causing transmission, to a last network node indicated for CHO preparation by the source network node, of an indicator to trigger additional CHO preparation toward other target network nodes and a list of cell identifiers of the respective other target network nodes.

Another method is provided, including receiving an indication from a user equipment (UE) served by a source network node in a network, to trigger condition handover (CHO) preparation with a plurality of target network nodes in a path in which the UE moves, and triggering CHO preparation with the plurality of target network nodes by causing transmission, toward a respective recipient target network node, of a cell identifier of a next target network node of the recipient target network node, and a cell identifier of a preceding network node of the recipient target network node.

An apparatus is provided, including means for triggering conditional handover (CHO) preparation toward a plurality of target network nodes in a path along which a user equipment (UE) is determined to move, wherein the means for CHO preparation comprises means for causing transmission, toward a respective recipient target network node, of a cell identifier of a next target network node of the recipient target network node, and, if a preceding network node of the recipient target node is not the apparatus, a cell identifier of the preceding network node of the recipient target network node.

The apparatus further includes means for causing transmission, toward a last network node triggered for CHO preparation by the apparatus, of an indicator to trigger additional CHO preparation toward other target network nodes and a list of cell identifiers of the respective other target network nodes.

According to certain embodiments, the path in which the UE is determined to move comprises a path from the apparatus, configured as a first network node, to a second network node, to a third network node, and to a fourth network node, wherein the CHO preparation further comprises causing transmission, toward the second network node, of a cell identifier of the third network node, and causing transmission, toward the third network node, of a cell identifier of the fourth network node and a cell identifier of the second network node.

The indicator to trigger the additional CHO preparation, and the list of cell identifiers are transmitted from the apparatus toward the fourth network node. The apparatus further includes means for causing transmission, toward the UE, of an indication of a sequence of CHO conditions to be evaluated, wherein a respective CHO condition is associated with a respective network node in the path in which the UE is determined to move.

Another apparatus is provided, including means for receiving from a source network node a cell identifier of a next target network node, and means for performing early data forwarding toward the next target network node. The apparatus further incudes means for receiving an indication, from the source network node, to trigger conditional handover (CHO) preparation toward a plurality of target network nodes indicated by the source network node, and in response thereto, trigger the CHO preparation toward the plurality of target network nodes.

The apparatus further includes means for receiving from the source network node a cell identifier of a preceding network node and in response thereto, means for causing transmission of a handover success message to the preceding network node based on the cell identifier.

The apparatus further includes means for receiving an indication of a sequence of conditional handover (CHO) conditions to be evaluated, wherein a respective CHO condition is associated with a respective network node in a path along which the apparatus is determined to move, and means for determining a conditional handover (CHO) condition to be evaluated for a next network node toward which the apparatus moves, based on a cell identifier of a source network node and path information of the apparatus. The path information of the apparatus is received from a network entity and comprises respective cell identifiers of network nodes toward which the apparatus moves.

An apparatus is provided, including means for causing transmission, to a source network node, of an indicator to trigger CHO preparation to target network nodes in a path along which the apparatus moves, and a list of cell identifiers of the respective target network nodes, means for receiving from the source network node, an indication of conditional handover (CHO) conditions to be evaluated, wherein a respective CHO condition is associated with a respective one of the target network nodes according to the path, and means for evaluating a respective CHO condition for a next network node toward which the apparatus moves.

The apparatus further includes means for causing transmission, to a last network node indicated for CHO preparation by the source network node, of an indicator to trigger additional CHO preparation toward other target network nodes and a list of cell identifiers of the respective other target network nodes.

The apparatus further includes means for receiving an indication from a user equipment (UE) served by the apparatus in a network, to trigger condition handover (CHO) preparation with a plurality of target network nodes in a path in which the UE moves, and means for triggering CHO preparation with the plurality of target network nodes by causing transmission, toward a respective recipient target network node, of a cell identifier of a next target network node of the recipient target network node, and a cell identifier of a preceding network node of the recipient target network node.

A computer program product is provided, including at least one non-transitory computer-readable medium having computer-executable program instructions stored thereon for performing at least the following: triggering conditional handover (CHO) preparation toward a plurality of target network nodes in a path along which a user equipment (UE) is determined to move. The CHO preparation comprises causing transmission, toward a respective recipient target network node, of a cell identifier of a next target network node of the recipient target network node, and, if a preceding network node of the recipient target node is not a source network node of the cell identifier of the next target node, a cell identifier of the preceding network node of the recipient target network node.

The computer-executable program instructions further comprise program instructions to cause transmission, toward a last network node triggered for CHO preparation by the source network node, of an indicator to trigger additional CHO preparation toward other target network nodes and a list of cell identifiers of the respective other target network nodes.

According to certain embodiments, the path in which the UE is determined to move comprises a path from the source network node, configured as a first network node, to a second network node, to a third network node, and to a fourth network node, wherein the CHO preparation further comprises cause transmission, toward the second network node, of a cell identifier of the third network node, and cause transmission, toward the third network node, of a cell identifier of the fourth network node and a cell identifier of the second network node.

The indicator to trigger the additional CHO preparation, and the list of cell identifiers are transmitted from the source network node toward the fourth network node. The computer-executable program instructions further comprise program instructions to cause transmission, toward the UE, of an indication of a sequence of CHO conditions to be evaluated, wherein a respective CHO condition is associated with a respective network node in the path in which the UE is determined to move.

Another computer program product is provided, including at least one non-transitory computer-readable medium having computer-executable program instructions stored thereon, for performing at least the following: receive from a source network node a cell identifier of a next target network node, and perform early data forwarding toward the next target network node.

The computer-executable program instructions further comprise program instructions to receive an indication, from the source network node, to trigger conditional handover (CHO) preparation toward a plurality of target network nodes indicated by the source network node, and in response thereto, trigger the CHO preparation toward the plurality of target network nodes.

The computer-executable program instructions further comprise program instructions to receive from the source network node a cell identifier of a preceding network node and in response thereto, cause transmission of a handover success message to the preceding network node based on the cell identifier.

Another computer program product is provided, including at least one non-transitory computer-readable medium having computer-executable program instructions stored thereon, for performing at least the following: receiving an indication of a sequence of conditional handover (CHO) conditions to be evaluated, wherein a respective CHO condition is associated with a respective network node in a path along which a user equipment (UE) is determined to move, and determine a conditional handover (CHO) condition to be evaluated for a next network node toward which the UE moves, based on a cell identifier of a source network node and path information of the UE. The path information of the UE is received from a network entity and comprises respective cell identifiers of network nodes toward which the UE moves.

Another computer program product is provided, comprising at least one non-transitory computer-readable medium having computer-executable program instructions stored thereon, for performing at least the following: causing transmission, to a source network node, of an indicator to trigger CHO preparation to target network nodes in a path along which a user equipment (UE) moves, and a list of cell identifiers of the respective target network nodes, receive from the source network node, an indication of conditional handover (CHO) conditions to be evaluated, wherein a respective CHO condition is associated with a respective one of the target network nodes according to the path, and evaluate a respective CHO condition for a next network node toward which the UE moves. The computer-executable program instructions further comprise program instructions to cause transmission, to a last network node indicated for CHO preparation by the source network node, of an indicator to trigger additional CHO preparation toward other target network nodes and a list of cell identifiers of the respective other target network nodes.

A computer program product is provided, including at least one non-transitory computer-readable medium having computer-executable program instructions stored thereon for performing at least the following: receiving an indication from a user equipment (UE) served by a source network node in a network, to trigger condition handover (CHO) preparation with a plurality of target network nodes in a path in which the UE moves, and trigger CHO preparation with the plurality of target network nodes by causing transmission, toward a respective recipient target network node, of a cell identifier of a next target network node of the recipient target network node, and a cell identifier of a preceding network node of the recipient target network node.

### BRIEF DESCRIPTION OF THE DRAWINGS

Having thus described certain embodiments of the present disclosure in general terms, reference will hereinafter be made to the accompanying drawings, which are not necessarily drawn to scale, and wherein:

FIG. 1 spans two pages, and is a schematic illustrating a condition handover;

FIG. 2 is a schematic illustrating an example movement of a hyperloop train moving between example cells, according to certain embodiments of the present disclosure:

FIG. 3 is a block diagram of an apparatus that is specifically configured in accordance with an example embodiment of the present disclosure: and

FIGS. 4 and 5 each span two pages, and are flowcharts of operations implemented by network entities, according to certain embodiments of the present disclosure.

FIGS. 6A, 6B, and 7-10 are flowcharts of operations implemented by network entities, according to certain embodiments of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure are embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry): (b) combinations of circuits and computer program product(s) comprising software and/or firmware instructions stored on one or more computer readable memories that work together to cause an apparatus to perform one or more functions described herein: and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

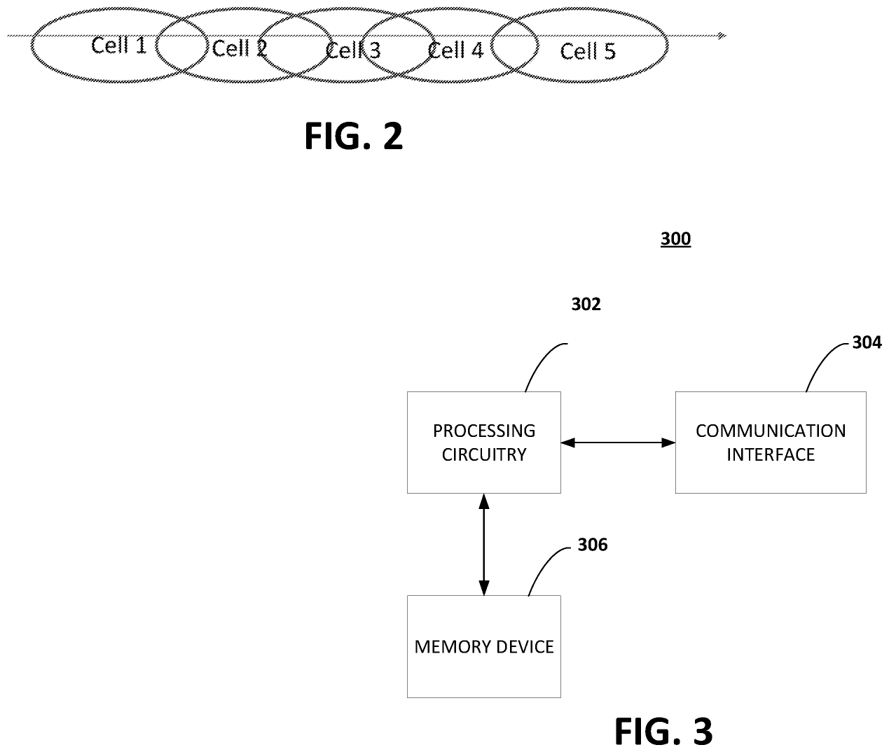

An example of an apparatus 300 that is configured to function as a network entity, such as a UE 100, a network node or cell (such as but not limited to a Next Generation NodeB (gNB)), a source network node 102, target network node 104, and/or other network nodes discusses herein, and/or the like, is provided in FIG. 3.

The apparatus 300 includes, is associated with or is in communication with processing circuity 302, a memory device 306 and a communication interface 304. The processing circuitry 302 is in communication with the memory device via a bus for passing information among components of the apparatus 300. The memory device 306 may be non-transitory and may include, for example, one or more volatile and/or non-volatile memories. In other words, for example, the memory device 306 may be an electronic storage device (e.g., a computer readable storage medium) comprising gates configured to store data (e.g., bits) that may be retrievable by a machine (e.g., a computing device like the processing circuitry). The memory device 306 may be configured to store information, data, content, applications, instructions, or the like for enabling the apparatus to carry out various functions in accordance with an example embodiment of the present disclosure. For example, the memory device 306 could be configured to buffer input data for processing by the processing circuitry 302. Additionally or alternatively, the memory device 306 could be configured to store instructions for execution by the processing circuitry 302.

The apparatus 300 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 302 may be embodied in a number of different ways. For example, the processing circuitry 302 may be embodied as one or more of various hardware processing means such as at least one processor, coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 302 may be configured to execute instructions stored in the memory device 306 or otherwise accessible to the processing circuitry 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. As another example, when the processing circuitry 302 is embodied as an executor of instructions, the instructions may specifically configure the processing circuitry and/or processor to perform the algorithms and/or operations described herein when the instructions are executed. However, in some cases, the processing circuitry 302 may be a processor of a specific device (e.g., an image or video processing system) configured to employ an embodiment of the present disclosure by further configuration of the processing circuitry by instructions for performing the algorithms and/or operations described herein. The processing circuitry 302 may include, among other things, a clock, an arithmetic logic unit (ALU) and logic gates configured to support operation of the processing circuitry.

The processing circuitry 302 may include or embody one or more types of circuitry configured to perform a particular function. As described below, for example, the processing circuitry may embody one or more of measurement report circuitry, CHO request initiation circuitry, CHO request transmission circuitry, trigger circuitry, CHO evaluation circuitry, RRC configuration message indication circuitry, CHO preparation trigger circuitry and/or early data forwarding circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

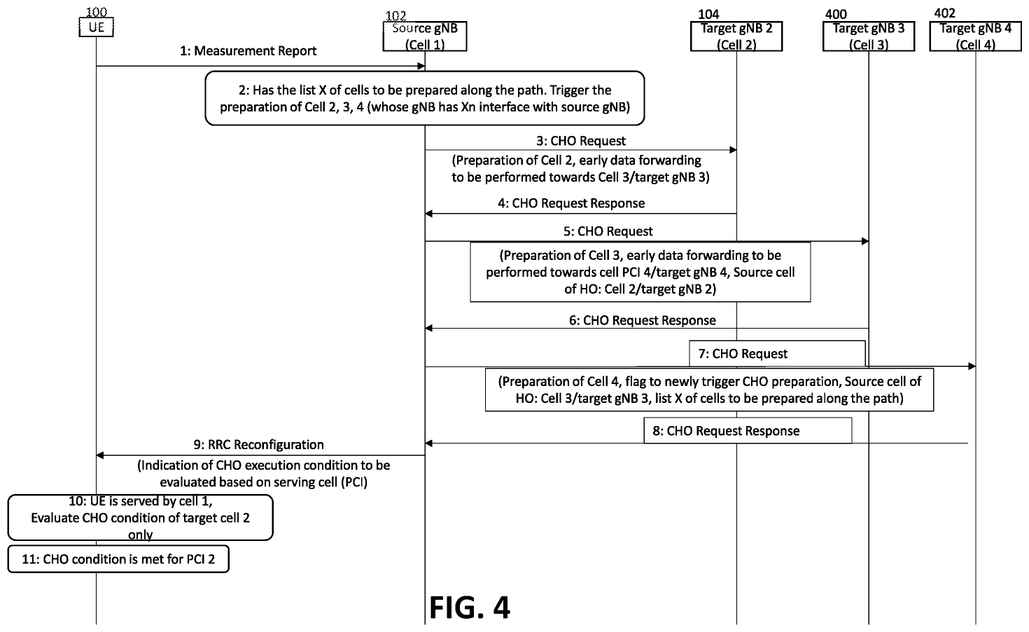

Referring now to FIG. 4, an example sequence diagram implemented, for example, by apparatus 300, such as a UE 100, source gNB or network node 102 (cell 1), and/or a plurality of target gNB or network nodes 104 (cell 2), 400 (cell 3), and 402 (cell 4), is discussed herein. The sequence diagram of FIG. 4 is implemented according to the first technique when path information for the UE is known in the network, but not necessarily the UE.

In operation 1 of FIG. 4, apparatus 300 such as the UE 100 includes means, such as processing circuitry 302, e.g., measurement report circuitry, communication interface 304, and/or the like, to send a measurement report, toward cell 1. Cell 1 receives from a network entity, a list X of cells, such as including PCIs to be prepared along the path (operation 2). The list may include a sequenced listing of target cells, or an indication of the order of cells toward which the UE is to move, enabling triggering, by apparatus 300 with means such as processing circuity 302 and via communication interface 304, of the preparation of cells 2, 3 and 4, whose gNB each has an Xn interface with the source gNB (cell 1).

In operation 3 of FIG. 4, apparatus 300, such as the source network node (cell 1) includes means such as processing circuitry 302, e.g., CHO request initiation circuitry, communication interface 304, and/or the like, to initiate a CHO request toward cell 2, which further initiates early data forwarding from cell 2 to cell 3. Cell 2 responds to cell 1 via a CHO request response at operation 4. Operation 5 includes causing transmission, with means such as processing circuitry 302, e.g., CHO request transmission circuitry, communication interface 304, and/or the like, of a CHO request toward cell 3, initiating preparation of cell 3 with an indication of a source cell of the handover as cell 2, and further initiating early data forwarding to be performed towards the cell 4. In operation 7 of FIG. 4, the CHO Request is transmitted by apparatus 300 using means such as processing circuity 302, e.g., the CHO request transmission circuitry, and communication interface 304 from cell 1 to cell 4, as well as a flag or indicator to trigger new or additional CHO preparation toward a list of additional target network nodes or target cells. The list of target network nodes is also provided to cell 4 with an indication of the path and/or order of cells toward which the UE will travel. Apparatus 300, such as cell 4, includes means such as processing circuitry 302, e.g., trigger circuitry, communication interface 304, and/or the like, to trigger iterations similarly as the source network node, to continue CHO preparation toward additional target network nodes in the path, and transmits a CHO Response in operation 8.

In operation 9, the RRC Reconfiguration message transmitted by apparatus 300 with means such as processing circuity 302 and communication interface 304 from the source network node to the UE indicates the serving cell PCI, and therefore an indication of the CHO execution condition to be evaluated in the UE. In this regard, apparatus 300 implemented as UE 100 does not necessarily perform all CHO evaluations as the CHO conditions are received, but rather includes means, such as processing circuitry 302, CHO evaluation circuitry, and memory device 306, to determine based on a sequence of determined network nodes along the path, the next network node and associated CHO condition to evaluate. In this regard, after the UE receives the RRC reconfiguration, the UE can start to evaluate the CHO condition of the next target cell along the path.

In operation 10, the apparatus 300, such as UE 100 includes means, such as processing circuity 302, e.g., the CHO evaluation circuitry, and communication interface 304, to receive, determine or identify an indication, such as the PCI, of the serving cell 1, and can therefore evaluate, using processing circuitry 302, the CHO condition associated with the next target network node according to path information provided by the network. Once the CHO condition for cell 2 is satisfied or met (operation 12), the UE 100 initiates at operation 13 a random access, with means such as processing circuitry 302, communication interface 304, and/or the like, toward the identified network node and receive a handover success message at operation 13. Data forwarding occurs at operation 14 from cell 2 to cell 3, and as shown by operation 15, the UE 100 is now served by cell 2 as it moves along the path. Apparatus 300 including UE 100, such as with processing circuity 302, e.g., CHO evaluation circuitry, and according to operation 15, begins evaluating the CHO condition for cell 3 only (based on the PCI of cell 3 indicated in the path information). Once the CHO condition is met in operation 16, the operation 17 random access procedure to cell 3 by the UE 100, operation 18 handover success from cell 3 to cell 2, and data forwarding by cell 3 in operation 19 are similarly performed as in operations 12-14.

At operation 20, while apparatus 300 such as the UE 100 is served by cell 3, the UE 100, such as with processing circuitry 302, e.g., the CHO evaluation circuitry, evaluates the CHO condition for cell 4, and once met (operation 21), performs the random access procedure at operation 22 toward cell 4 with means such as communicating interface 304. Apparatus 300, such as cell 4, includes means for, such as processing circuity 302 and communication interface 304, causing transmission of a handover success message to cell 3 in operation 23. Cell 4 also begins triggering new or additional CHO preparation with cells further along the path in operation 24, such that operations illustrated in FIG. 4 are iteratively repeated and that cell 4 can function as a source network node to other target network nodes as the UE 100 moves along the path.

It will be appreciated that the 4 cells of FIG. 4 are provided merely as an example, and that any number of cells can be prepared for CHO by a source network node. A last network node (e.g., cell 4) is instructed to trigger additional CHO preparation toward other target network nodes, such that the cell in turn serves as a source network node to additional target cells. Operation 24 indicates the responsibility of triggering CHO preparation that shifts from one source cell to another cell.

It will be further appreciated that in certain embodiments, target network node cell 4 can trigger the new CHO preparation (operation 24) immediately after operation 8 but provides these prepared conditional reconfigurations after the UE 100 completes the handover execution to target cell 4 in operation 22.

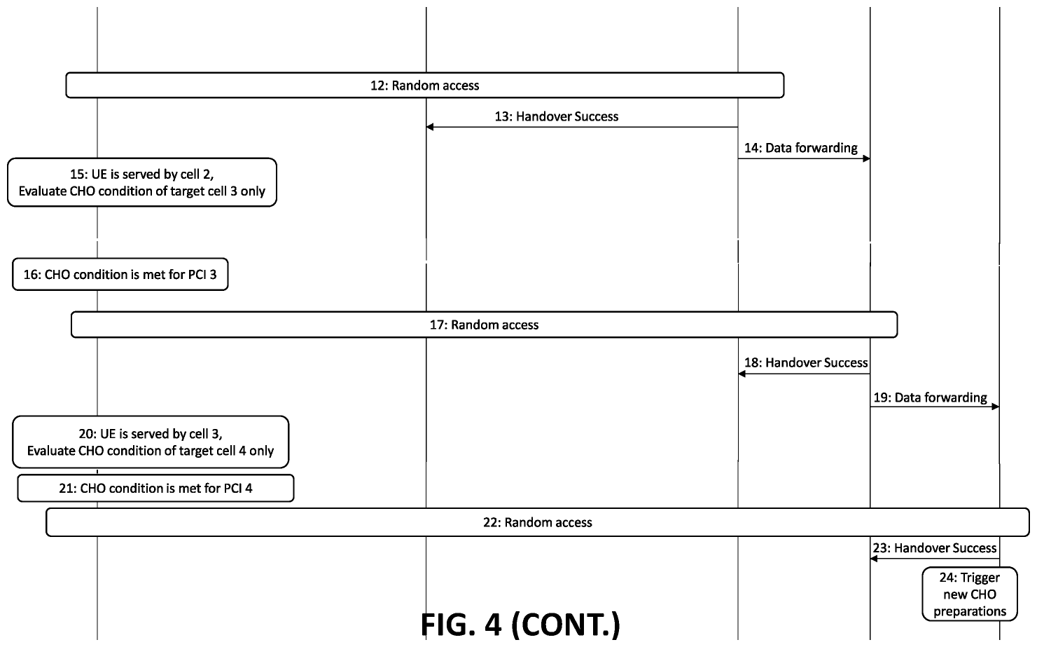

While FIG. 4 is a sequence diagram of operations of the first technique according to certain embodiments in which the path information is known in the network, FIG. 5 is a sequence diagram of operations of the second technique according to certain embodiments in which the path information is known by the UE 100.

FIG. 5 has some similarities to FIG. 4 with at least some of the differences described below. As noted in Aspect #6 described above, and operation 1 in FIG. 5, based on the list X of cells that the UE 100 will visit along its path, the apparatus 300 embodied by UE 100 includes means for, such as processing circuitry 302 and communication interface 304, informing serving cell 1, the source gNB, about the next candidate target cells. Upon receiving this information, apparatus 300 embodied by the source cell, cell 1, triggers the preparation of the candidate target network node 104 (cell 2), target network node 400 (cell 3) and target network node 402 (cell 4). The source gNB may not need to include the flag and the list X of cells as it can be informed by the UE 100 as shown in operation 24 of FIG. 5 as described in further detail below (and with regard to Aspect #7 described herein).

As shown in operation 1 of FIG. 5, the apparatus 300, such as UE 100, has the list X of cells to be prepared along the path, as is stored in memory device 306, and further includes means, such as processing circuitry 302 and communication interface 304, for causing transmission to the source gNB cell 1, an indication to prepare candidate target cells from list X, as set forth by operation 2. As shown by operation 3, apparatus 300, such as source gNB, cell 1, includes means for, such as processing circuitry 302, e.g., cell preparation trigger circuitry,, communication interface 304, and/or the like, triggering preparation of cells 2, 3, and 4, each having a respective gNB having an Xn interface with source gNB. In operation 4, apparatus 300, such as cell 1, includes means, such as processing circuitry 302, communication interface 304, and/or the like, for transmitting a CHO request toward cell 2, initiating preparation of cell 2 and early data forwarding toward cell 3. In operation 5, cell 2 includes means, such as processing circuitry 302, communication interface 304, and/or the like, for returning a CHO request response to cell 1.

In operation 6, apparatus 300 embodied by source network node gNB cell 1 includes means, such as processing circuitry 302, communication interface 304, and/or the like, for transmitting a CHO request toward cell 3, initiating preparation of cell 3 and early data forwarding toward cell 4. The source network node or gNB, cell 1, further indicates to cell 3, the source cell of the handover as cell 2 to enable the cell 3 to later indicate handover success (operation 19). In operation 7, cell 3 includes means, such as processing circuitry 302, communication interface 304, and/or the like for returning a CHO request response to cell 1.

In operation 8, apparatus 300 embodied by source network node gNB cell 1 includes means, such as processing circuitry 302, communication interface 304, and/or the like, for transmitting a CHO request toward cell 4, initiating preparation of cell 4. The source network node or gNB, cell 1, further indicates to cell 4, the source cell of the handover as cell 3 to enable the cell 4 to later indicate handover success (operation 25). In operation 9, apparatus 300 embodied by cell 4 includes means, such as processing circuitry 302, communication interface 304, and/or the like, for returning a CHO request response to cell 1.

In operation 10, source network node, or source gNB cell 1 includes means, including processing circuitry 302, e.g., RRC configuration message indication circuitry, communication interface 304, and/or the like, for indicating to the UE 100, an RRC reconfiguration message including the CHO conditions for the prepared cells, such as cells 2, 3 and 4.

As shown by operation 11, when UE 100 is served by cell 1, the apparatus 300 embodied by UE 100 includes means, such as processing circuitry 302, e.g., CHO evaluation circuitry, for evaluating the CHO condition for cell 2. Once the CHO condition is met or satisfied at operation 12, the UE 100 includes means, such as processing circuitry 302 and communication interface 304, for performing a random access procedure towards cell 2. Cell 2, with means including processing circuitry 302 and communication interface 304, indicates handover success to cell 1 at operation 14, and begins data forwarding in operation 15 toward cell 3.

Operations 16-20 include similar operations to operations 11-15, as the UE 100 moves toward cell 3 and/or after the UE 100 begins moving toward cell 3. Operations 21-23 are similar to operations 11-13 and operations 16-18. In operation 24, UE 100 includes means, such as processing circuitry 302 and communication interface 304, for indicating to cell 4 to prepare a new set of candidate target cells, and the list X of cells along the path. Cell 4 further indicates with means such as processing circuitry 302 and communication interface 304, handover success to cell 3 at operation 25. Cell 4 can further act as a source network node and can repeat the process described with respect to FIG. 5, including triggering new CHO preparation indicated by operation 26.

It will be appreciated that the 4 cells of FIG. 5 are provided merely as an example, and that any number of cells can be prepared for CHO by a source cell. The CHO preparation triggered by a source network node can therefore be triggered for any number of network nodes. A last network node (e.g., cell 4) is instructed to trigger additional CHO preparation toward other target network nodes, such that the cell in turn serves as a source gNB to additional cells. Operation 26 indicates the responsibility of triggering CHO preparation that shifts from one source cell to another.

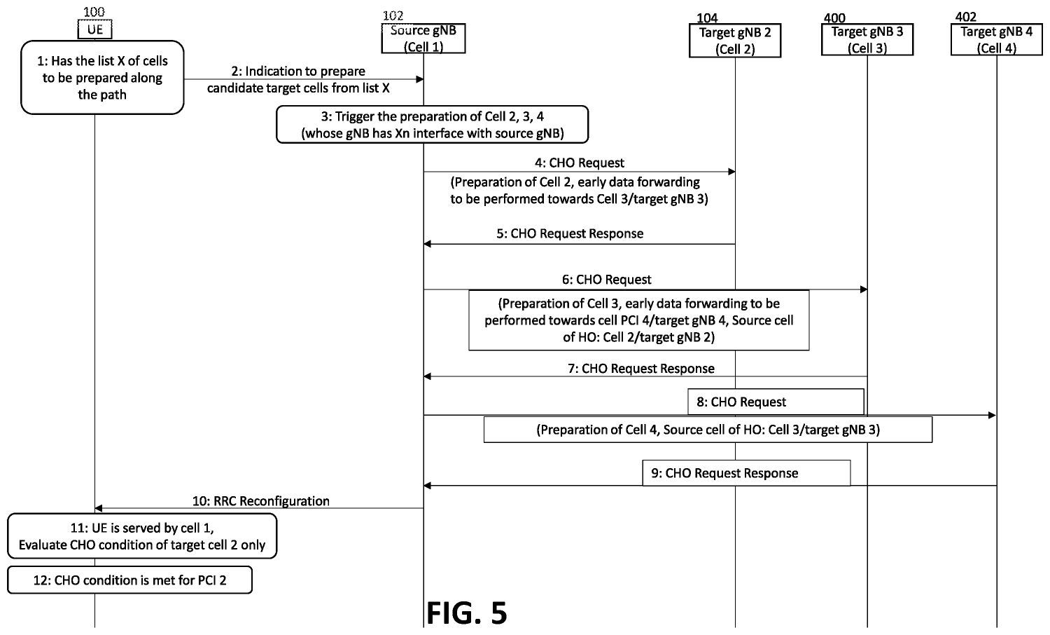

FIG. 6A is a flowchart of operations that are performed by an apparatus 300 embodied by a network entity, such as source gNB 102, or source network node 102, such as cell 1 of FIG. 4, according to the first technique.

In operation 600, the apparatus 300 embodied by a network entity, such as source network node 102, may include means, such as the processing circuitry 302, e.g. CHO preparation trigger circuitry, communication interface 304, or the like, for triggering conditional handover (CHO) preparation toward a plurality of target network nodes in a path along which a user equipment (UE) is determined to move. See for example, Aspect #1 described above, and FIG. 4 operations 3, 5, and 7. In certain embodiments, triggering the CHO preparation includes operation 602.

In operation 602, the apparatus 300 embodied by a network entity, such as source network node 102, may include means, such as the processing circuitry 302, e.g. CHO preparation trigger circuitry, communication interface 304, or the like, for, triggering the CHO preparation by causing transmission, toward a respective recipient target network node, of a cell identifier of a next target network node of the recipient target network node. In this regard, the means for triggering the CHO preparation includes means for causing transmission, toward a respective recipient target network node, of a cell identifier of a next target network node of the recipient target network node. See for example, FIG. 4 operations 3, 5, and 7. Further according to operation 602, based on a preceding network node of the recipient target node not being the apparatus, the apparatus 300 embodied by a network entity, such as source network node 102, may include means, such as the processing circuitry 302, communication interface 304, or the like, for causing transmission of a cell identifier of the preceding network node of the recipient target network node. Said differently, if the preceding network node of the recipient target node is not the apparatus, certain example embodiments cause transmission of the cell identifier of the preceding network node. See for example, Aspect #3, and FIG. 4 operations 5 and 7.

In operation 604, the apparatus 300 embodied by a network entity, such as source network node 102, may include means, such as the processing circuitry 302, communication interface 304, or the like, for causing transmission, toward a last network node triggered for CHO preparation by the apparatus (e.g., source network node 102), of an indicator to trigger additional CHO preparation toward other target network nodes and a list of cell identifiers of the respective other target network nodes. See at least Aspect #4, and FIG. 4, operation 7. The indicator to trigger the additional CHO preparation, and the list of cell identifiers are transmitted from the apparatus (e.g., source network node 102) toward the fourth network node. See at least Aspect #3 described herein.

In operation 606, the apparatus 300 embodied by a network entity, such as source network node 102, may include means, such as the processing circuitry 302, communication interface 304, or the like, for causing transmission, toward the UE, of an indication of a sequence of CHO conditions to be evaluated, wherein a respective CHO condition is associated with a respective network node in the path in which the UE is determined to move. See at least Aspect #5 described above, and FIG. 4, operation 9. For instance, the serving cell can indicate that the CHO execution condition of target cell 2 shall be evaluated when the UE is served by serving cell 1, CHO execution condition of target cell 3 shall be evaluated when the UE is served by cell 2, and so on.

FIG. 6B is a flowchart of operations that may be performed by an apparatus 300 embodied by a network entity, such as source gNB or network node, such as cell 1, according to the first method and an example embodiment. According to an example embodiment, the path in which the UE is determined to move comprises a path from the apparatus (a first network node such as the source network node 102 of FIG. 4), to a second network node (e.g., cell 2 of FIG. 4), to a third network node (e.g., cell 3 of FIG. 4), and to a fourth network node (e.g., cell 4 of FIG. 4).

In operation 610, the apparatus 300 embodied by a network entity, such as source network node 102, may include means, such as the processing circuitry 302, e.g. CHO preparation trigger circuitry, communication interface 304, or the like, for triggering CHO preparation comprises causing transmission, toward the second network node, of a cell identifier of the third network node. See at least Aspect #2 described herein, and FIG. 4, operation 3.

In operation 612, the apparatus 300 embodied by a network entity, such as source network node 102, may include means, such as the processing circuitry 302, communication interface 304, or the like, for causing transmission, toward the third network node, of a cell identifier of the fourth network node and a cell identifier of the second network node. See at least FIG. 4, operation 5.

In operation 614, the apparatus 300 embodied by a network entity, such as

source network node 102, may include means, such as the processing circuitry 302, communication interface 304, or the like, for causing transmission, toward the fourth network node, of the indicator to trigger the additional CHO preparation, and the list of cell identifiers. See at least Aspect #4, and FIG. 4, operation 7.

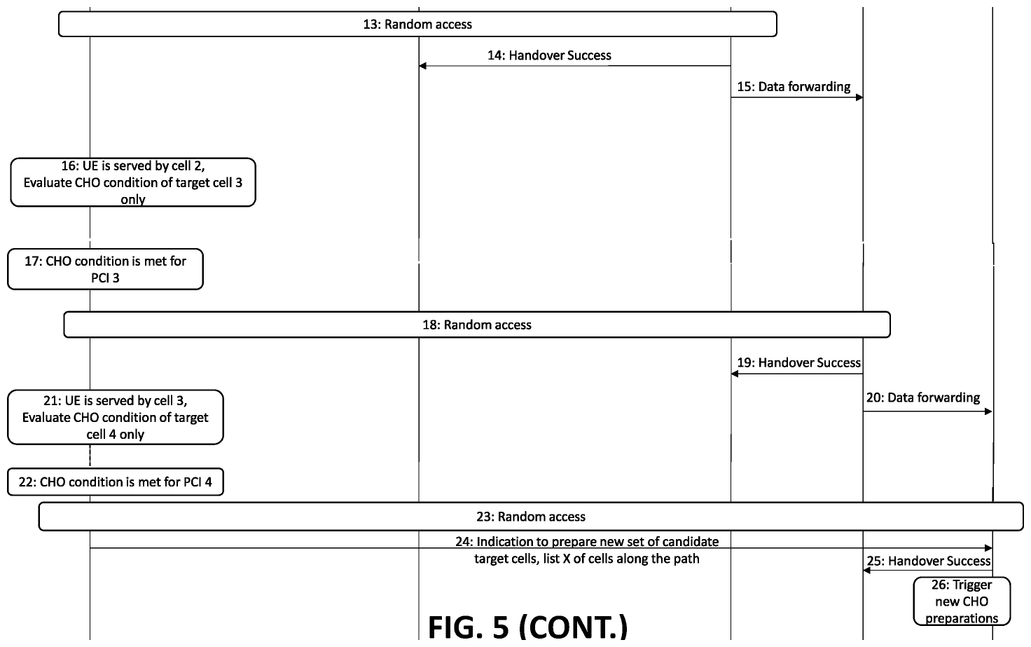

FIG. 7 is a flowchart of operations that are performed by an apparatus 300 embodied by a network entity, such as a target gNB or network node, such as any of cells 2-4 (e.g., target network nodes 104, 400, and 402) in FIGS. 4 and 5, according to the first and second methods.

In operation 700, the apparatus 300 embodied by a network entity, such as target network node 104, may include means, such as the processing circuitry 302, communication interface 304, or the like, for receiving from a source network node a cell identifier of a next target network node. See at least Aspects #2 and #3 described herein, operations 3, 5, and 7 of FIG. 4, and operations 4, 6 and 8 of FIG. 5.

In operation 702, the apparatus 300 embodied by a network entity, such as target network node 104, may include means, such as the processing circuitry 302, e.g., early data forwarding circuitry, communication interface 304, or the like, for performing early data forwarding toward the next target network node. See at least Aspects #2 and #3 described herein, operations 3, 5, and 7 of FIG. 4, and operations 4, 6 and 8 of FIG. 5.

In operation 704, the apparatus 300 embodied by a network entity, such as target network node 104, may include means, such as the processing circuitry 302, e.g. CHO preparation trigger circuitry, communication interface 304, or the like, for receiving an indication, from the source network node, to trigger conditional handover (CHO) preparation toward a plurality of target network nodes indicated by the source network node, and in response thereto, trigger the CHO preparation toward the plurality of target network nodes. See at least Aspect #4, and FIG. 4, operation 24.

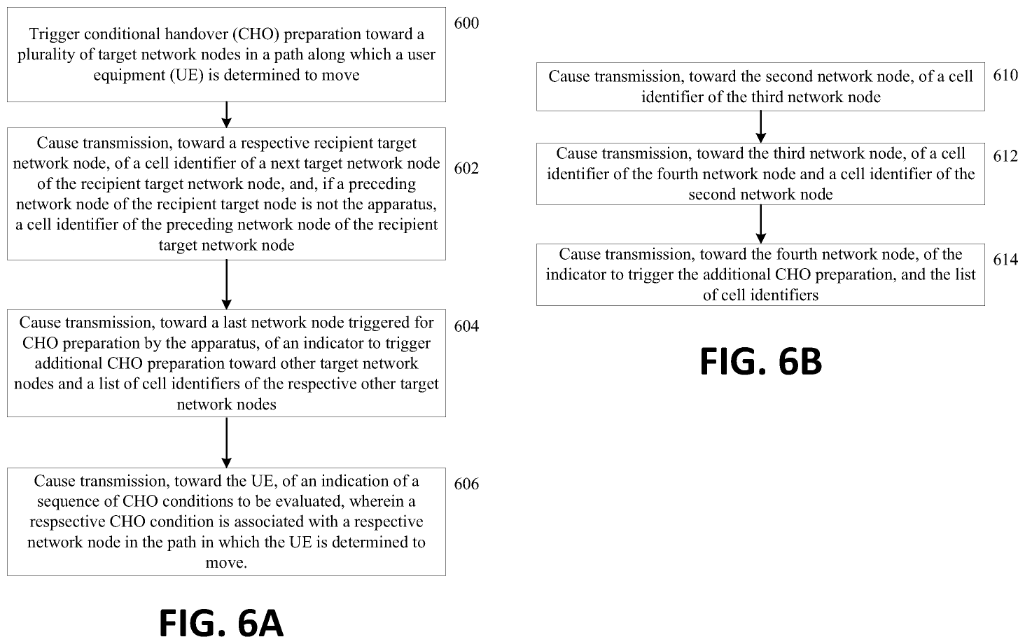

FIG. 8 is a flowchart of operations that are performed by an apparatus 300 embodied by a network entity, such as a UE 100, according to the first technique.

In operation 800, the apparatus 300 embodied by a network entity, such as UE 100, may include means, such as the processing circuitry 302, communication interface 304, or the like, for receiving an indication of a sequence of conditional handover (CHO) conditions to be evaluated, wherein a respective CHO condition is associated with a respective network node in a path along which the apparatus is determined to move.

In operation 802, the apparatus 300 embodied by a network entity, such as UE 100, may include means, such as the processing circuitry 302, communication interface 304, or the like, for determining a conditional handover (CHO) condition to be evaluated for a next network node toward which the apparatus (e.g., UE) moves, based on a cell identifier of a source network node and path information of the apparatus (e.g., UE).

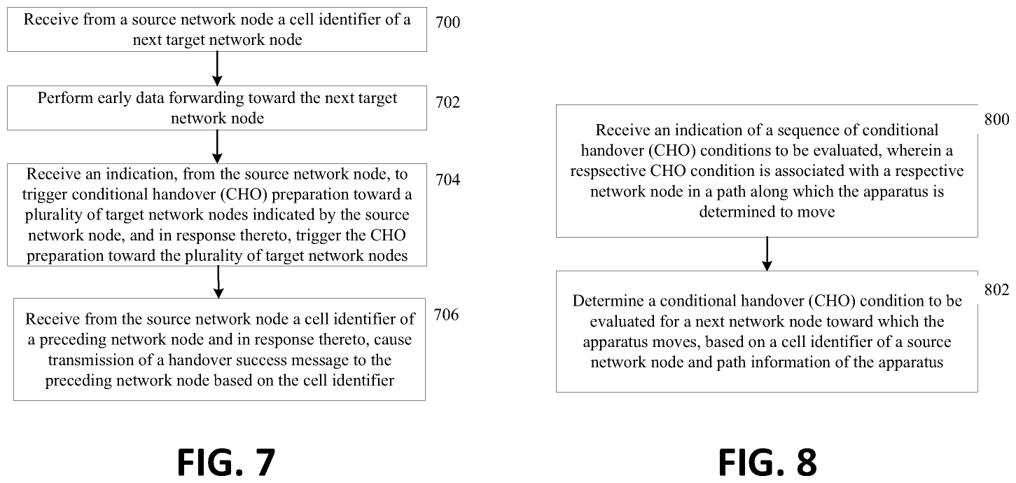

FIG. 9 is a flowchart of operations that are performed by an apparatus 300 embodied by a network entity, such as a UE 100, according to the second technique.

In operation 900, the apparatus 300 embodied by a network entity, such as UE 100, may include means, such as the processing circuitry 302, communication interface 304, or the like, for causing transmission, to a source network node, of an indicator to trigger CHO preparation to target network nodes in a path along which the apparatus moves, and a list of cell identifiers of the respective target network nodes. See at least Aspect #6 described herein, and operations 1 and 2 of FIG. 5.

In operation 902, the apparatus 300 embodied by a network entity, such as UE 100, may include means, such as the processing circuitry 302, communication interface 304, or the like, for receiving from the source network node, an indication of conditional handover (CHO) conditions to be evaluated, wherein a respective CHO condition is associated with a respective one of the target network nodes according to the path. See for example the RRC Reconfiguration indicated in operation 10 of FIG. 5.

In operation 904, the apparatus 300 embodied by a network entity, such as UE 100, may include means, such as the processing circuitry 302, communication interface 304, or the like, for evaluating a respective CHO condition for a next network node toward which the apparatus (e.g., UE) moves. See at least Aspect #8 described herein, and operations 11, 16, and 21 of FIG. 5.

In operation 906, the apparatus 300 embodied by a network entity, such as UE 100, may include means, such as the processing circuitry 302, communication interface 304, or the like, for cause transmission, to a last network node indicated for CHO preparation by the source network node, of an indicator to trigger additional CHO preparation toward other target network nodes and a list of cell identifiers of the respective other target network nodes. See at least Aspect #7, described herein, and operation 24 of FIG. 5.

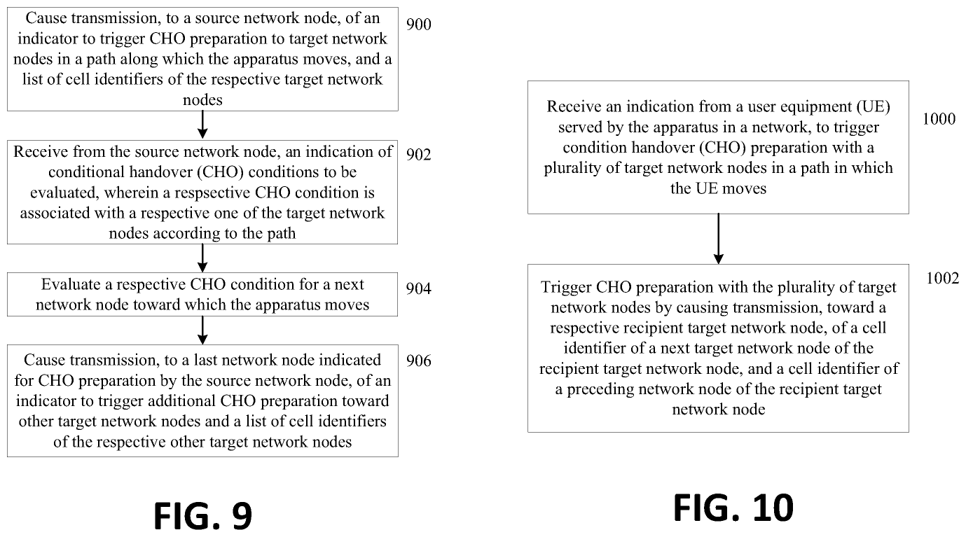

FIG. 10 is a flowchart of operations that are performed by an apparatus 300 embodied by a network entity, such as source gNB or network node, such as cell 1 of FIG. 5, according to the second technique.

In operation 1000, the apparatus 300 embodied by a network entity, such as source network node 102, may include means, such as the processing circuitry 302, communication interface 304, or the like, for receiving an indication from a user equipment (UE) served by the apparatus in a network, to trigger condition handover (CHO) preparation with a plurality of target network nodes in a path in which the UE moves. See at least Aspect #6 described herein, and operation 2 of FIG. 5.

In operation 1002, the apparatus 300 embodied by a network entity, such as source network node 102, may include means, such as the processing circuitry 302, e.g. CHO preparation trigger circuitry, communication interface 304, or the like, for triggering CHO preparation with the plurality of target network nodes by causing transmission, toward a respective recipient target network node, of a cell identifier of a next target network node of the recipient target network node, and a cell identifier of a preceding network node of the recipient target network node. See at least Aspect #1 and #3, and operations 3, 4, 6, and 8 of FIG. 5.

Accordingly, certain embodiments disclosed herein enable the network and associated network entities to reduce signaling overhead associated with early data forwarding that could otherwise occur toward more cells than what is needed for the UE to move along a path. Certain embodiments further enable the target node to know toward which source gNB of handover to send “Handover Success” message in CHO. For example, the target gNB or network node 400 (e.g., cell 3) sends the “Handover Success” message to the source gNB or network node 102 in order to indicate to source gNB or network node 104, that the UE has performed CHO execution (the source gNB or network node 104 is not aware of this until it receives this information). Using this information, the source gNB network node 102 can stop scheduling and send the final Sequence Number (SN) Status Transfer message indicating for the target gNB the ID of the next downlink packets that shall be delivered to the UE in downlink and the next uplink packets that shall be delivered to UPF. Target gNB or network node 400, or cell 3 is prepared early when the UE was served by gNB1. As such, target gNB or network node 400, or cell 3 does not know where to send handover success. In this case, the source gNB or network node 104, cell 1, informs a target network node about the ID of the previous cell along the path.

Certain embodiments direct the target gNB controlling the last prepared candidate target cell to trigger the CHO preparation for the next upcoming candidate target cells along the path, and reduce the complexity at the UE by limiting the measurement evaluation only to the CHO condition of next target cell along the path. An example embodiment is therefore particularly useful in a high-speed train scenario in which continuous connectivity is also desired, and the path of the UE is known or can be determined.

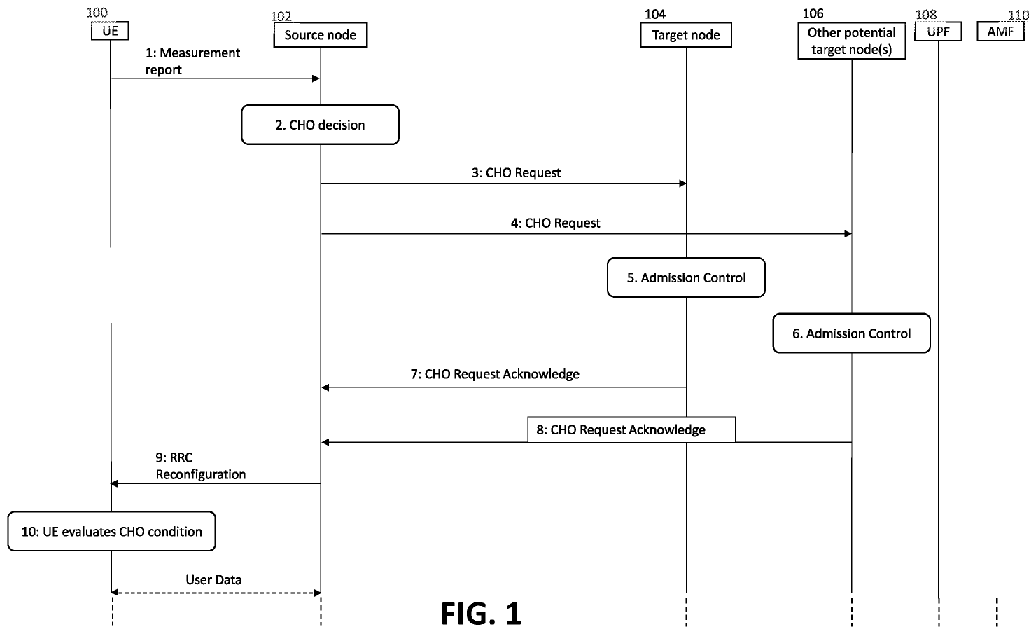

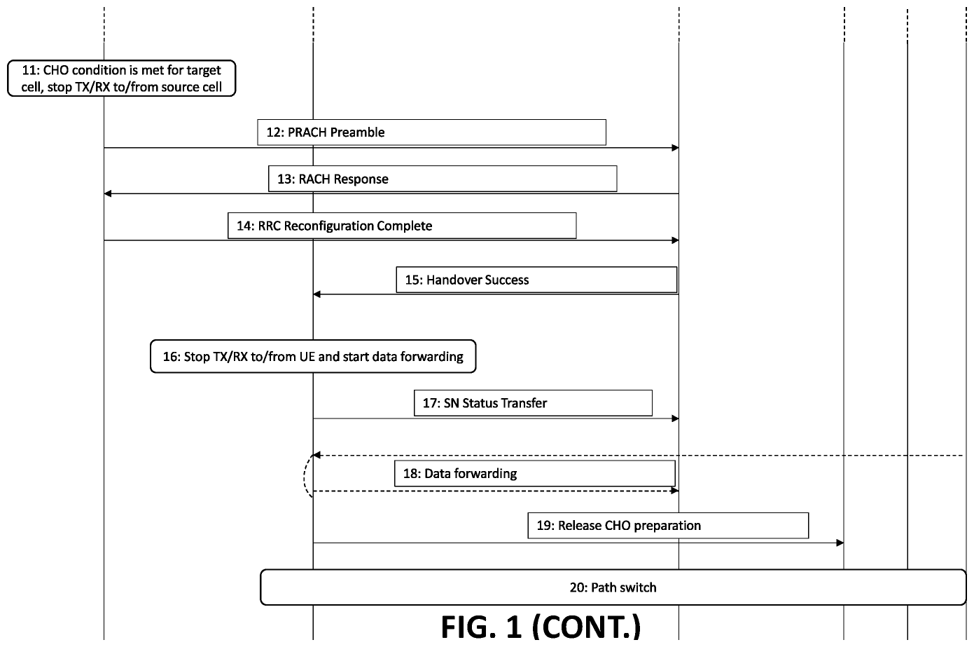

FIGS. 1, and 4, 5, 6A, 6B, and 7-10 illustrate message flows and flow charts depicting methods according to an example embodiment of the present disclosure. It will be understood that each block of the message flow may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above is stored by a memory device 306 of an apparatus 300 employing an embodiment of the present disclosure and executed by the processing circuitry 302, such as one or more processors. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions are stored in a computer-readable memory that directs a computer or other programmable apparatus to function in a particular manner, such that the instructions stored in the computer-readable memory produce an article of manufacture the execution of which implements the function specified in the flowchart blocks. The computer program instructions are loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts and message flows support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims.

Moreover, although the foregoing descriptions and the associated drawings describe certain embodiments in the context of certain example combinations of elements and/or functions, it should be appreciated that different combinations of elements and/or functions are provided by alternative embodiments without departing from the scope of the appended claims. In this regard, for example, different combinations of elements and/or functions than those explicitly described above are also contemplated as are set forth in some of the appended claims. Although specific terms are employed herein, they are used in a generic and descriptive sense only and not for purposes of limitation.

Although a few variations have been described in detail above, other modifications or additions are possible. In particular, further features and/or variations are provided in addition to those set forth herein. Moreover, the implementations described above are directed to various combinations and sub-combinations of the disclosed features and/or combinations and sub-combinations of several further features disclosed above. Other embodiments are provided within the scope of the following claims.

If desired, the different functions discussed herein can be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes certain embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

It should therefore again be emphasized that the various embodiments described herein are presented by way of illustrative example only and should not be construed as limiting the scope of the claims. For example, alternative embodiments can utilize different communication system configurations, user equipment configurations, base station configurations, identity request processes, messaging protocols and message formats than those described above in the context of the illustrative embodiments. In this regard, at least some of the embodiments have been described in conjunction with a particular type of network, e.g., a 5G NR network. However, the disclosed embodiment may be utilized in conjunction with other types of networks including networks developed and implemented hereinafter. These and numerous other alternative embodiments within the scope of the appended claims will be readily apparent to those skilled in the art.

1-52. (canceled)

53. An apparatus, comprising:
at least one processor and at least one memory storing instructions that, when executed by the at least one processor, cause the apparatus at least to:
cause transmission, to a source network node, of an indicator to trigger conditional handover (CHO) preparation to a plurality of target network nodes in a path along which the apparatus moves, and a list of cell identifiers of the respective target network nodes;
receive from the source network node, an indication of CHO conditions to be evaluated, wherein a respective CHO condition is associated with a respective one of the plurality of target network nodes according to the path; and
evaluate a respective CHO condition for a next network node toward which the apparatus moves.

54. The apparatus according to claim 53, wherein the instructions, when executed by the at least one processor, further cause the apparatus to:
cause transmission, to a last network node indicated for CHO preparation by the source network node, of an indicator to trigger additional CHO preparation toward other target network nodes and a list of cell identifiers of the respective other target network nodes.

55. The apparatus according to claim 53, wherein the path along which the apparatus moves comprises a path from the source network node, configured as a first network node, to a second network node, and to a third network node, wherein evaluating a respective CHO condition for a next network node comprises at least one of:
evaluating CHO condition for the second network node when the apparatus is served by the first network node, or
evaluating CHO condition for the third network node when the apparatus is served by the second network node.

56. The apparatus according to claim 53, wherein the path along which the apparatus moves comprises a path from the source network node, configured as a first network node, to a second network node, to a third network node, and to a fourth network node, wherein the evaluating a respective CHO condition for a next network node comprises at least one of:
evaluating CHO condition for the second network node when the apparatus is served by the first network node,
evaluating CHO condition for the third network node when the apparatus is served by the second network node, or
evaluating CHO condition for the fourth network node when the apparatus is served by the third network node.

57. The apparatus according to claim 53, wherein the indication of CHO conditions is received in a radio resource control message.

58. The apparatus according to claim 57, wherein the radio resource control message comprises a radio resource control reconfiguration message.

59. The apparatus according to claim 53, wherein the instructions, when executed by the at least one processor, further cause the apparatus at least to:
in response to the respective CHO condition for the next network node is met, perform random access procedure to the next network node.

60. The apparatus according to claim 53, wherein the apparatus comprises or is comprised in a user equipment.

61. An apparatus comprising:
at least one processor and at least one memory storing instructions that, when executed by the at least one processor, cause the apparatus at least to:
receive an indication from a user equipment served by the apparatus in a network, to trigger condition handover (CHO) preparation with a plurality of target network nodes in a path along which the UE moves; and
cause transmission, toward the user equipment, an indication of a sequence of CHO conditions to be evaluated, wherein a respective CHO condition is associated with a respective one of the plurality of target network nodes according to the path.

62. The apparatus according to claim 61, wherein the instructions, when executed by the at least one processor, further cause the apparatus at least to:
trigger CHO preparation with the plurality of target network nodes by causing transmission, toward a respective recipient target network node, of a cell identifier of a next target network node of the recipient target network node, and a cell identifier of a preceding network node of the recipient target network node if the preceding network node of the recipient target node is not the apparatus.

63. The apparatus according to claim 61, wherein the instructions, when executed by the at least one processor, further cause the apparatus at least to:
cause transmission, toward a last network node triggered for CHO preparation by the apparatus, of an indicator to trigger additional CHO preparation toward other target network nodes and a list of cell identifiers of the respective other target network nodes.

64. The apparatus according to claim 61, wherein the path in which the user equipment is determined to move comprises a path from the apparatus, configured as a first network node, to a second network node, to a third network node, and to a fourth network node, wherein the CHO preparation further comprises:
causing transmission, toward the second network node, of a cell identifier of the third network node; and
causing transmission, toward the third network node, of a cell identifier of the fourth network node and a cell identifier of the second network node.

65. The apparatus according to claim 64, wherein the CHO preparation further comprises:
causing transmission, toward the second network node, of an indication of early data forwarding from the second network node to the third network node; and
causing transmission, toward the third network node, of an indication of early data forwarding from the third network node to the fourth network node.

66. The apparatus according to claim 65, wherein the indication of early data forwarding is transmitted in a CHO request message.

67. The apparatus according to claim 61, wherein the apparatus comprises or is comprised in a serving network node.

68. A method comprising:
causing transmission, from a user equipment to a source network node, of an indicator to trigger conditional handover (CHO) preparation to a plurality of target network nodes in a path along which the user equipment moves, and a list of cell identifiers of the respective target network nodes;
receiving from the source network node, an indication of CHO conditions to be evaluated, wherein a respective CHO condition is associated with a respective one of the plurality of target network nodes according to the path; and
evaluating a respective CHO condition for a next network node toward which the user equipment moves.

69. The method according to claim 68, further comprising:
causing transmission, to a last network node indicated for CHO preparation by the source network node, of an indicator to trigger additional CHO preparation toward other target network nodes and a list of cell identifiers of the respective other target network nodes.

70. The method according to claim 68, wherein the path along which the user equipment moves comprises a path from the source network node, configured as a first network node, to a second network node, to a third network node, and to a fourth network node, wherein the evaluating a respective CHO condition for a next network node comprises at least one of:
evaluating CHO condition for the second network node when the user equipment is served by the first network node,
evaluating CHO condition for the third network node when the user equipment is served by the second network node, or
evaluating CHO condition for the fourth network node when the user equipment is served by the third network node.

71. The method according to claim 68, wherein the indication of CHO conditions is received in a radio resource control message.

72. The method according to claim 68, further comprising:
in response to the respective CHO condition for the next network node is met, performing random access procedure to the next network node.
